(19) United States
(12) Patent Application Publication
(10) Pub. No.: US 2015/0206362 A1
(43) Pub. Date: Jul. 23, 2015

(54) METHOD, SYSTEM, AND KIT FOR MAKING AN ASSET MONITORABLE BY A SECURITY ASSET MANAGEMENT SYSTEM

(71) Applicant: Key Systems, Inc., Fishers, NY (US)

(72) Inventor: George H. Eckerdt, Victor, NY (US)

(73) Assignee: Key Systems, Inc., Fishers, NY (US)

(21) Appl. No.: 14/673,735

(22) Filed: Mar. 30, 2015

Related U.S. Application Data
(63) Continuation-in-part of application No. 10/644,383, filed on Aug. 19, 2003.
Application No. 10/644,383 is a continuation-in-part of application No. 14/266,221, filed on Apr. 30, 2014.
(60) Provisional application No. 61/973,019, filed on Mar. 31, 2014.
(60) Provisional application No. 60/404,158, filed on Aug. 19, 2002.
(60) Provisional application No. 61/818,117, filed on May 1, 2013.

(51) Int. Cl. G07C 9/00; G06K 19/077

(52) U.S. Cl. CPC G07C 9/00007; G06K 19/07745

(57) ABSTRACT

An identification insert can enable tracking of an asset by placing identification circuitry with a unique identifier in communication with a security asset management system. The insert can be directly mounted in a housing of an asset. Alternatively, the insert can be mounted in an ID enabler that can be attached to an asset via a cable or the like. The insert can also be part of a lock adapter secured to an asset by a lock, or can be mounted in a housing of a lock compatible with a security feature of an asset, such as a lock slot.

### BACKGROUND

The claimed invention generally relates to methods and systems for security asset management.

There is a need to store and track valuable assets, such as, but not limited to computers and peripherals. It is desirable to have a system and method to monitor access to those assets, such that certain assets are automatically logged out to authorized users when taken, following presentation of accepted identification. Furthermore, there is a need for the system to be able to recognize when a particular asset has been returned.

### SUMMARY

According to one embodiment of the present invention, an identification (ID) insert can include an ID communication interface and identification circuitry electrically coupled to the ID communication interface. The ID circuitry can include an electronic identifier of the ID insert, and a support layer can be coupled to and configured to support the ID communication interface and the identification circuitry.

Another embodiment of the invention disclosed herein can include a security asset management system in which an identification (ID) insert can have an ID communication interface, identification circuitry that can be electrically coupled to the ID communication interface, and a unique electronic identifier that can be included in the identification circuitry. A support layer can be supportingly coupled to the ID communication interface and the identification circuitry, and a cable can include a connector compatible with the ID communication interface. In addition, a controller can be coupled to the cable, the cable placing the controller in electrical communication with the identification circuitry via the ID communication interface when the cable connector is connected to the ID communication interface of the ID insert. The controller can thereby selectively determine the presence and removal of an asset coupled to the ID insert based on the communications with the identification circuitry. The controller can further selectively store information about the asset based on the communications with the identification circuitry.

An additional embodiment of the invention disclosed herein can take the form of a security asset management system in which a server application running on a computing device can include at least one server communications device, and at least one electronic identification (ID) device can each include a unique electronic identifier associated with a respective asset to be tracked, each electronic ID device including an ID communication interface. In addition, the system can include at least one security asset manager (SAM) within which at least one asset to be tracked can be stored. Each SAM can include a controller, at least one respective first SAM communications device that can be coupled to and responsive to the respective controller and with which the respective SAM can selectively communicate with the server application via the at least one server communications device, and at least one second SAM communications device corresponding to an ID communication interface of the at least one electronic ID device can selectively enable communication between the controller and the at least one electronic ID device when the at least one electronic ID device is in the respective SAM.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically illustrates one embodiment of a security asset management system according to embodiments of the invention disclosed herein.

FIG. 2 schematically illustrates another embodiment of a security asset management system according to embodiments of the invention disclosed herein.

FIG. 3 illustrates one embodiment of an identification (ID) insert for attaching ID circuitry to an asset according to embodiments of the invention disclosed herein.

FIG. 4 illustrates one embodiment of ID circuitry housed within an embodiment of a cable adapter according to embodiments of the invention disclosed herein.

FIG. 5 illustrates the embodied adapter of FIG. 4 attached to an asset according to embodiments of the invention disclosed herein.

FIG. 6 illustrates an embodiment of ID circuitry housed within an embodiment of a lock adapter according to embodiments of the invention disclosed herein.

FIG. 7 is a top view the embodied adapter of FIG. 6 aligned with a lock and a security lock slot of an asset according to embodiments of the invention disclosed herein.

FIG. 8 shows an adapter, lock, and portion of an asset of FIG. 7 with adapter locked in place between the lock and the asset according to embodiments of the invention disclosed herein.

FIG. 9 is an elevational view of an adapter, lock, and asset like those of FIG. 7 according to embodiments of the invention disclosed herein.

FIG. 10 is an elevational view of the adapter, lock, and asset of FIG. 9 with the adapter locked in place between the lock and the asset according to embodiments of the invention disclosed herein.

FIG. 11 schematically illustrates another embodiment of a security asset management system.

FIG. 12 is a top view of a SAM-enabled lock incorporating identification circuitry according to embodiments of the invention disclosed herein.

FIG. 13 is a side view, taken along line 13-13, of the SAM-enabled lock of FIG. 12 according to embodiments of the invention disclosed herein.

FIGS. 14-18 are schematic cross sectional views of a portion of a lock or the like at stages of installing ID circuitry according to embodiments of the invention disclosed herein.

FIG. 19 is a schematic illustration of a tool that can be used to install ID circuitry according to embodiments of the invention disclosed herein.

FIGS. 20-21 are schematic cross sectional views of a portion of a lock as in FIGS. 14-18 illustrating use of the tool of FIG. 19.

FIG. 22 is a schematic illustration of another embodiment of a tool that can be used to install ID circuitry according to embodiments of the invention disclosed herein.

FIGS. 23-24 are schematic cross sectional views of a portion of a lock as in FIGS. 14-18 illustrating use of the tool of FIG. 22.

FIG. 25 is a schematic diagram of a kit for making an asset monitorable using ID circuitry according to embodiments of the invention disclosed herein.

FIGS. 26 and 27 are schematic illustrations of a kit like that of FIG. 27 including the tools of FIGS. 19 and 22, respectively, according to embodiments of the invention disclosed herein.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

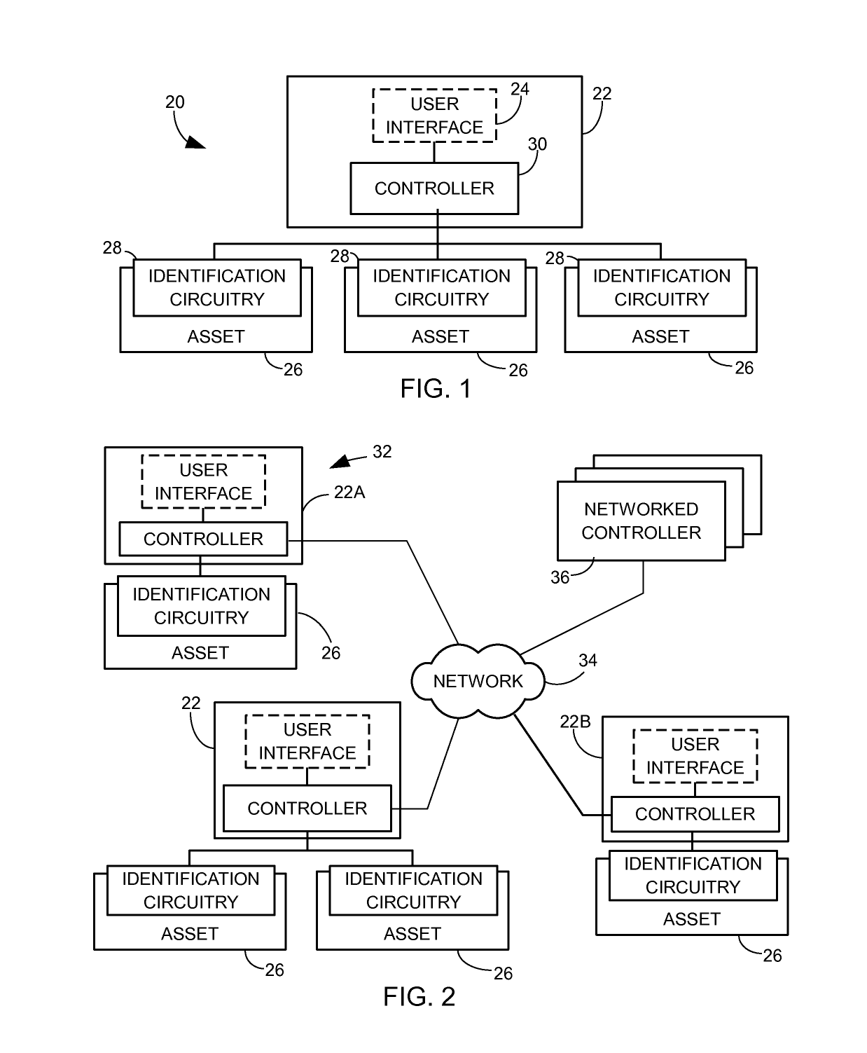

FIG. 1 illustrates one embodiment of a security asset management system 20. The system 20 includes a security asset manager (SAM) 22. Depending on the embodiment, the SAM 22 can have a user interface 24, comprising one or more of a variety of user identification (ID) devices, such as a keypad for personal identification number (PIN) entry, a fingerprint reader, and a proximity card reader. Those skilled in the art will understand that other types of user ID devices can be used, such as, but not limited to an iris ID device, a retinal scanning ID device, a hand shape ID device, and a magnetic card reader. The SAM 22 can also control one or more locked doors and/or lockers (not shown) which can be unlocked by the SAM 22 following the user identification.

In this embodiment, behind the one or more doors, authorized users can reach one or more assets 26. Assets can include, but are not limited to, portable computers, peripherals therefore, and/or other lock slot equipped devices, as well as tools, firearms, tablets, phones, keys, key cards, and/or other devices and/or objects. Each of the assets 26 can have its own ID circuitry 28 which is configured to have a unique electronic identifier which can be associated with its corresponding asset 26 and can include an ID communication interface. One suitable non-limiting example of ID circuitry is the DS2401P+ touch memory device from Maxim Integrated.

The SAM 22 can have a controller 30 coupled to the user interface 24. The controller 30 can also be removably coupled to the one or more assets 26 via their ID circuitry 28. The controller 30 can include, but is not limited to, a computer, a microprocessor, an application specific integrated circuit (ASIC), a field programmable gate array (FPGA), digital circuitry, analog circuitry, or any combination and/or plurality thereof, whether local or distributed. The controller 30 can communicate with an asset's ID circuitry 28, when it is coupled, using a suitable electronic communication scheme via the ID communication interface. One non-limiting example of a suitable communication scheme is the One Wire Communication Bus designed by Dallas Semiconductor Corp. The controller 30 can detect when an asset 26 has been connected to/plugged into or removed from the bus, and since only known authorized users are given access to the SAM 22, the controller 30 can monitor what assets are present, who has taken removed assets, and who has returned them.

FIG. 2 schematically illustrates another embodiment of a security asset management system 32. This embodiment includes a security asset manager (SAM) 22, the features of which have been discussed above. The SAM 22 can be coupled to and/or in communication with one or more other SAMs 22A, 22B via a network 34. One or more networked controllers 36 can also be coupled to one or more SAMs via the network 34. The network 34 can be, but is not limited to, a local area network (LAN), a wide area network (WAN), a wireless LAN, a wireless WAN, or any combination and/or plurality thereof. In some embodiments, one of the networked controllers 36 can be a server running asset management software for coordinating and collecting data from one or more SAMs 22, as well as providing reports on authorized user activity, asset status, and alarms. One suitable example of asset management software is the Global Facilities Management System software available from Key Systems, Inc. In other embodiments, another of the networked controllers 36 can include, but is not limited to, a computer, a laptop, a smartphone, and/or a cellular phone which is able to interact via a browser or other web enabled client with either a remote server running asset management software or an embedded web server in one of the SAMs 22. In a networked system, such as illustrated in FIG. 2, an asset 26 can be removed from and returned to any SAM 22, and the controller in each SAM can communicate the asset status to other controllers either directly or via a coordinating asset management software.

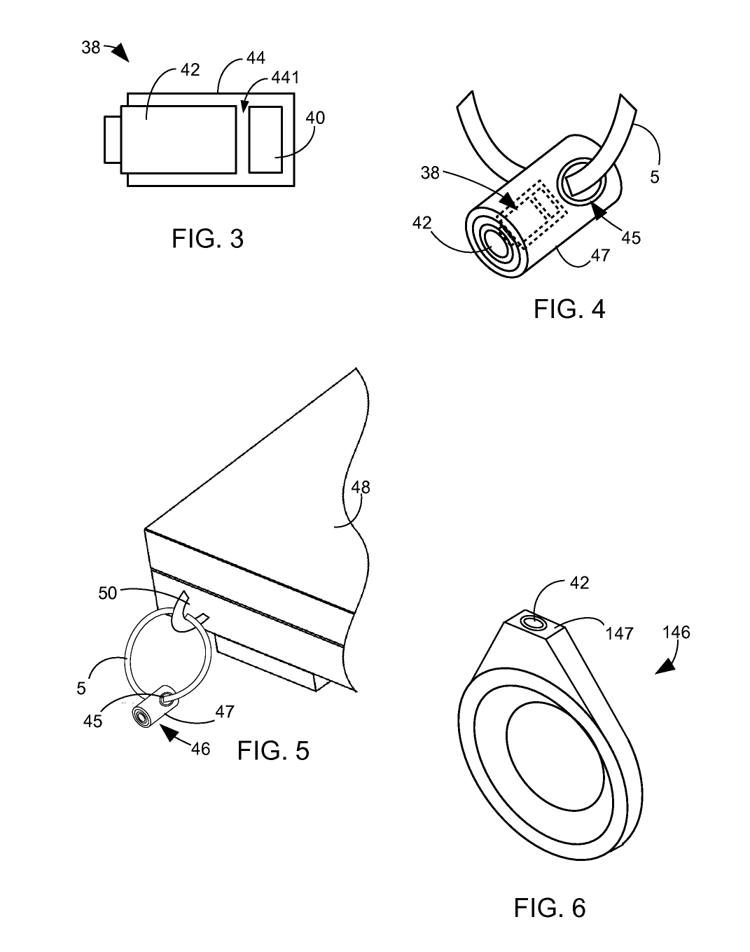

In order to track assets in security asset management systems, such as, but not limited to those discussed above, it is useful to have a way to attach ID circuitry to an asset in a manner that enables the ID circuitry to stay with the asset while allowing the attached ID circuitry to be removably coupled to the controller via an associated ID communication interface. FIG. 3 illustrates one embodiment of an ID insert 38 that can be used to enable an asset to be tracked with ID circuitry 40. ID insert 38 can include an ID communication interface, such as a plug receptacle 42, coupled to ID circuitry 40 and configured to communicate one or more electrical connections 441 (for example, a 1-wire data signal and a ground connection) to ID circuitry 40 when a mating plug is plugged into plug receptacle 42. It should be understood that plug receptacle 42 is one example of a suitable ID communication interface, but that other interfaces are within the scope of embodiments.

A circuit board 44 can support ID circuitry 40 and plug receptacle 42, and/or other components as may be appropriate, as well as electrical connections 441 therebetween. In embodiments where a “1-wire” or “touch memory” device is used as ID circuitry 40, plug receptacle 42 can provide two connections to ID circuitry 40: one for a shared power supply/data signal, and another for a ground connection. In embodiments, ID insert 38 can be placed directly into an asset to be monitored, such as by forming a cavity in a housing of the asset, inserting ID insert 38, and affixing ID insert 38 in the cavity, as will be explained below with reference to FIGS. 14-26. However, in other embodiments, it may be desirable to have ID insert 38 securable to an asset without having to modify the asset itself.

FIG. 4 illustrates one embodiment of an ID enabler 46 with which an ID insert 38 can be attached to an asset 48. ID enabler 46 can include a housing 47 in which ID insert 38 can reside. In embodiments, ID insert 38 can be positioned so that plug receptacle 42, or at least an end thereof, can be accessed at an otherwise open end 471 of ID enabler housing 47. ID enabler 46 can also include a conduit 45 or the like formed through housing 47 with which ID enabler 46 can be attached to an asset with a cable, ring, or the like. For example, FIG. 5 shows a portion of a device 48 and illustrates an example of an ID enabler 46 as shown in FIG. 4 attached to device 48 via a cable 5 run through a security feature 50, such as a loop or the like, of device 48 and through conduit 45 of ID enabler 46. While the example shown is generally cylindrical, it should be understood that any shape can be used so long as ID insert 38 can be accommodated within ID enabler 46.

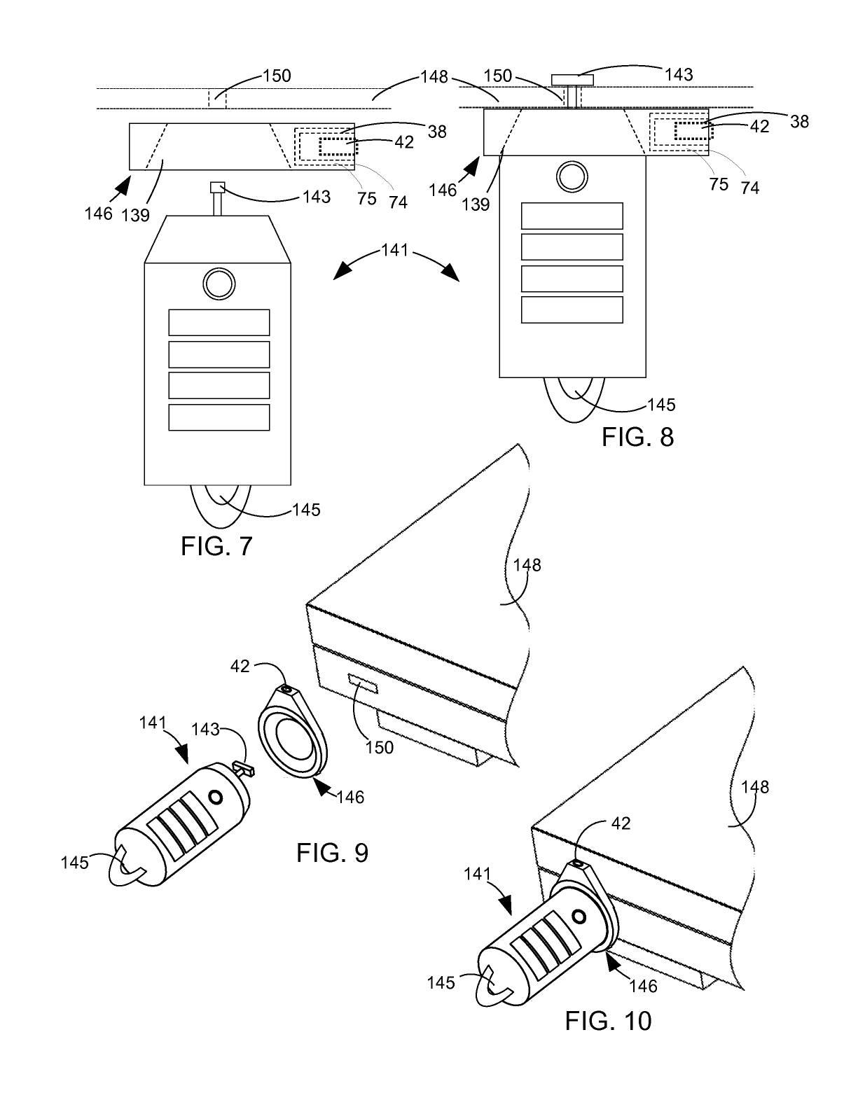

FIG. 6 illustrates another embodiment in which an ID insert 38 can be housed in an ID adapter 146. In similar fashion to ID enabler 46, ID adapter 146 can include a housing 147 in which ID insert 38 can reside. In embodiments, ID insert 38 can be position so that plug receptacle 42, or at least an end thereof, can be accessed through an opening 1471 of housing 147. With additional reference to FIGS. 7-10, housing 147 of ID adapter 146 can include an opening 139 shaped so that a security lock 141 can secure ID adapter 146 to an asset, such as a device 148. FIGS. 7 and 9 illustrate an example of an ID adapter 146 of FIG. 6 next to a portion of a device 148 equipped with a security feature, such as a lock slot 150, and a lock 141 compatible with lock slot 150. A suitable example of a lock slot with which embodiments can be used, and for which embodiments can be designed, is the ubiquitous Kesington® lock slot, which is formed in the housings or other portions of many popular devices, such as computers, printers, scanners, monitors/displays, and tablets. Lock 141 can include a tip 143 insertable into lock slot 150 and which can be manipulated to lock tip 143, and thus lock 141, in lock slot 150. Lock 141 can also include a conduit 145 or the like with which lock 141 and device 148 can be tethered to an object that can impede transport of device 148.

Opening 139 of ID adapter 146 can be sized and/or dimensioned and/or otherwise shaped and/or configured to fit over an end of lock 141 such that lock 141 and device 148 secure ID adapter 146 against removal from device 148 when lock 141 is locked in lock slot 50, as illustrated in FIGS. 6-10. In FIGS. 7 and 9, ID adapter 146 is shown aligned with lock 141 and lock slot 150 so that tip 143 of lock 141 can be inserted into lock slot 150 through ID adapter 146. As seen in FIGS. 8 and 10, when tip 143 of lock 141 has been so inserted, lock 141 engages ID adapter 146 in opening 139, securing ID adapter 146 to device 148. With ID adapter 146 thus secured to device 48, plug receptacle 42 can be readily accessed for coupling to a security asset manager (SAM) or the like as will be described. In embodiments, lock 141 and ID adapter 146 can remain on device 148 until device 148 is not to be managed by a security asset management system.

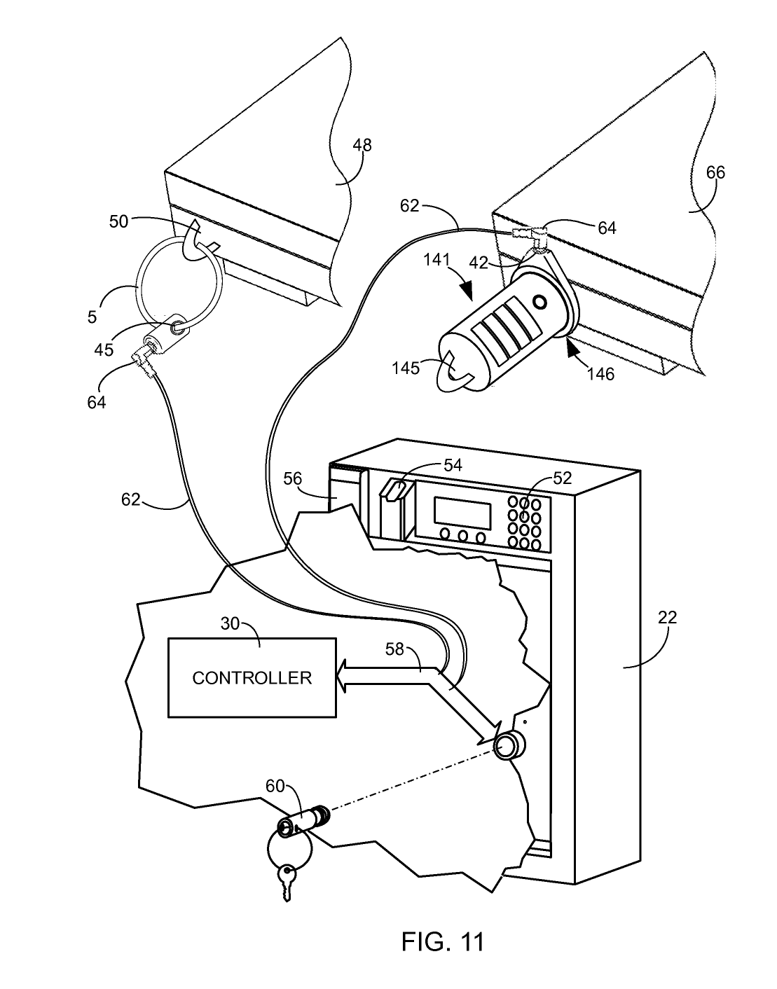

FIG. 11 schematically illustrates an embodiment of a security asset management system in a partially exploded view. As described above, the security asset management system can include a SAM 22 having a controller 30 coupled to a user interface, such as, but not limited to a keypad 52, a fingerprint reader 54, and/or a proximity card reader 56. Controller 30 can be coupled to a communication bus 58, such as, but not limited to, a Dallas Semiconductor 1-wire communication bus. A variety of devices can be coupled to communication bus 58, for example, a key fob 60 having identification circuitry which plugs directly into the SAM 22. Although not shown, some SAMs can also control one or more solenoids to enable directly controllable key entrapment and/or other latched asset control. One or more cables 62, coupled on one end to communication bus 58, can be provided with a respective plug 64 for coupling to assets with ID enablers 46 and/or ID adapters 146 that include identification circuitry. In this example, one or more assets 66, such as, but not limited to, laptop computers, can have an ID enabler 46 secured thereto by a key ring or the like, and/or can include an ID adapter 146 secured thereto by a lock 141. The ID circuitry (not visible in this view, but discussed above) of ID enabler 46 and/or ID adapter 146 can thus be associated with a respective asset 66, which can be coupled to controller 30 via a respective plug receptacle 42, plug 64, cable 62, and communication bus 58. Controller 30 can then sense and/or receive a respective unique electronic identifier from the ID circuitry of ID enabler 46 and/or ID adapter 146 and will know asset(s) 66 is present. SAM 22 can be set up so that an alarm will be triggered unless authorized persons, identified to the system through the user interface (for example by PIN number entry, finger print scan, or presentation of an access card), remove asset(s) 66. In order to remove an asset 66, its plug 64 can be disconnected from its associated plug receptacle 42. Upon disconnection of plug 64 from plug receptacle 42, the unique identifier (from the identification circuitry) associated with asset 66 will no longer be visible to controller 30, and controller 30 will know the asset 66 has been disconnected. Controller 30 can then automatically log asset 66 as out with the authorized user who had access at the time of removal. Similarly, when an asset 66 is returned and plugged back in via plug receptacle 42 of its respective ID enabler 46 and/or ID adapter 146, the unique identifier associated with the asset will become visible to the controller again. Thus, controller 30 will know asset 66 has been attached and can automatically be logged as having been returned by the authorized user who had access at the time of return. If an asset is removed by an unauthorized user, then an alarm can be set by the SAM 22.

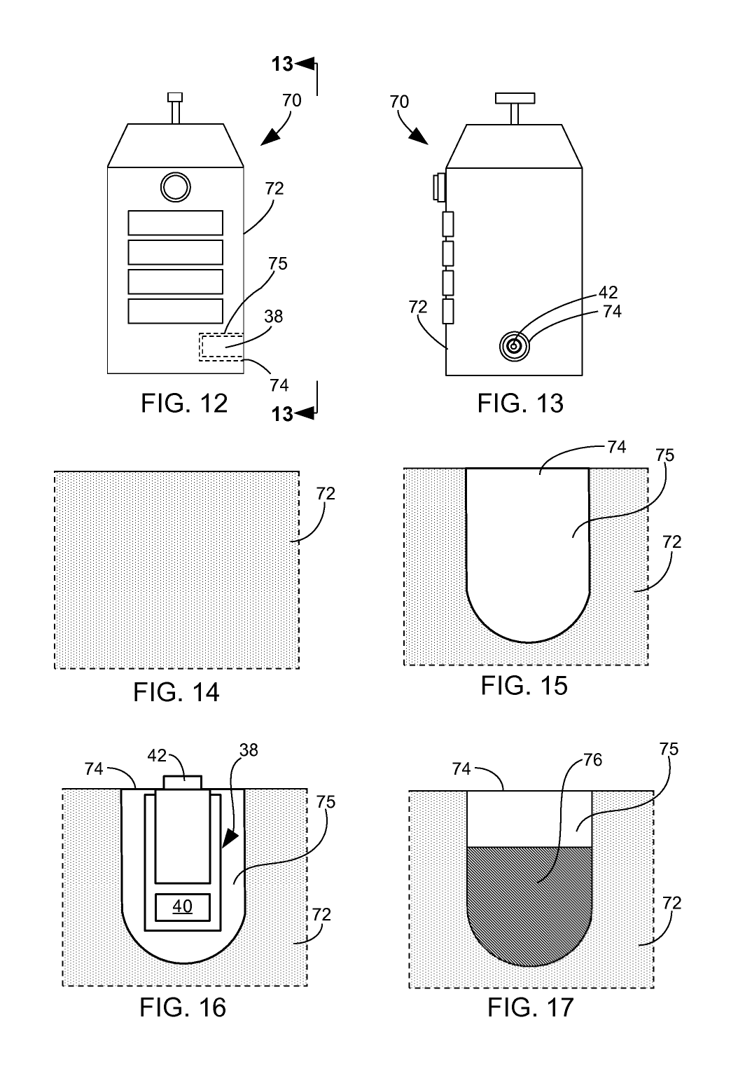

While ID circuitry can be locked to a device or other asset via an ID adapter 146 and lock 141 as shown in FIGS. 6-11, embodiments also contemplate, with reference to FIGS. 12 and 13, an ID-enabled lock 70 that can include an ID insert 38. As seen in FIGS. 12 and 13, ID-enabled lock 70 can include a housing 72 in which ID insert 38 can reside. With additional reference to FIG. 3, ID insert 38 can include a circuit board 44 supporting ID circuitry 40 and a plug receptacle 42. Housing 72 can include an opening 74 through which plug receptacle 42 of ID insert 38 can protrude and/or be accessed. In embodiments, a security lock, such as lock 141 shown in FIGS. 6-11, can be modified so that ID insert 38 can be inserted into and mounted in a cavity 75 in the lock housing so that plug receptacle 42 remains accessible from outside lock. The modification transforms security lock 141 into an ID-enabled security lock 70. In embodiments, cavity 75 can be pre-existing with no opening 74, in which case opening 74 can be drilled or otherwise formed to allow insertion of ID insert 38. In other embodiments, both opening 74 and cavity 75 can be formed as part of the modification.

FIGS. 14-18 illustrate an embodiment of a method for installing ID circuitry in a housing of a device to make it monitorable by a security asset management system. FIGS. 14 and 15 illustrate a portion of a housing 72 into which it is desired to install ID circuitry. In FIG. 14, no cavity is present, whereas in FIG. 15, opening 74 and cavity 75 are present, whether pre-existing or formed as part of modification of housing 72. In embodiments, cavity 75 already exists but is inaccessible, and so opening 74 can be formed, such as by drilling or another suitable process. However, other embodiments can require formation of both opening 74 and cavity 75, such as by drilling, milling, boring, laser ablation, and/or any other suitable technique. In any case, cavity 75 should be large enough to accommodate at least a desired portion of ID insert 38

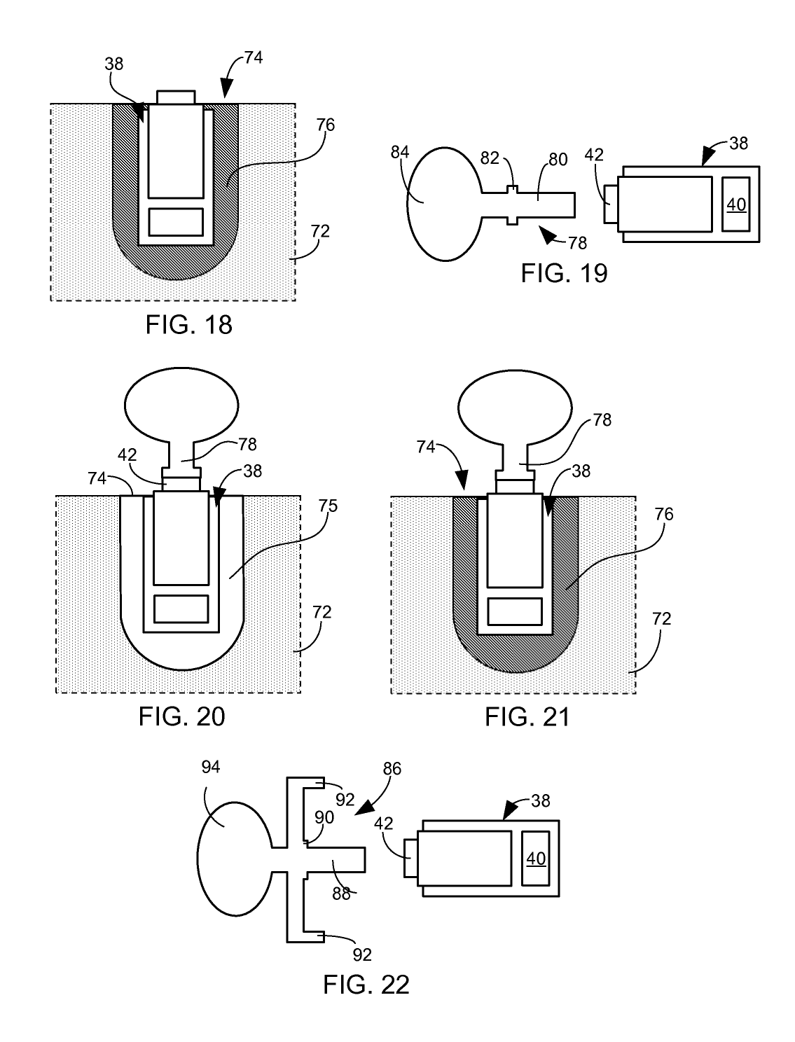

As illustrated in FIG. 16, an ID insert 38 can be inserted into cavity 75, such as with ID circuitry 40 and most of plug receptacle 42 in cavity 75, the tip of plug receptacle 42 protruding from cavity 75 or at least accessible via opening 74. The remainder of cavity 75 around ID insert 38 can be filled with filler 76, leaving plug receptacle 42 readily accessible, as illustrated in FIG. 18. Filler 76 can include, but is not limited to, an epoxy, electronic grade silicone rubber, fiberglass, resin, adhesive, plastic, and/or other suitable material. As just one example, a five-minute epoxy from Loctite, UPC #079340686175 can be used as filler 76. When filler 76 has cured, the asset that includes housing 72 is ID-enabled and ready for use with a security asset management system as described above. It should be noted that filler 76 can be placed in cavity 75 before ID insert 38 is inserted into cavity 75 in embodiments, in which case appropriate volume should be left in cavity 75 to allow such insertion of ID insert 38 without obstructing or impeding access to plug receptacle 42.

To help keep filler 76 out of the plug receptacle of the ID insert when installing the ID insert into a lock or an asset, a tool or plug or even adhesive tape can be used to seal off the plug receptacle while also enabling good handling of the ID insert. For example, FIG. 19 illustrates one embodiment of an insert alignment tool 78 that can be used to install an ID insert 38 (having ID circuitry 40) in a housing 72 of an asset, and which can be used to hold ID insert 38 in the installation method shown in FIGS. 14-18. As seen in FIG. 20, insert alignment tool 78 can include a tip 80 sized to be inserted into and removably held by plug receptacle 42 of ID insert 38. Insert alignment tool 78 can also have a flange 82 to prevent insert alignment tool 78 from being inserted too far into plug receptacle 42, and to provide a barrier to help prevent filler from getting into plug receptacle 42, as shown in FIG. 21. Insert alignment tool 78 can also have a handle 84 to make it easier to position ID insert 38 when ID insert 38 is attached to insert alignment tool 78. In some embodiments, insert alignment tool 78 can be made from a material to which the filler will not bond so that insert alignment tool 78 can be more easily removed after the filler has cured. In addition, insert alignment tool 78 can be used to control a depth of insertion of ID insert 38, such as with flange 82. When filler 76 has cured, insert alignment tool 78 can be removed from plug receptacle 42, leaving ID insert 38 embedded in filler 76 in cavity 75 as shown in FIG. 18.

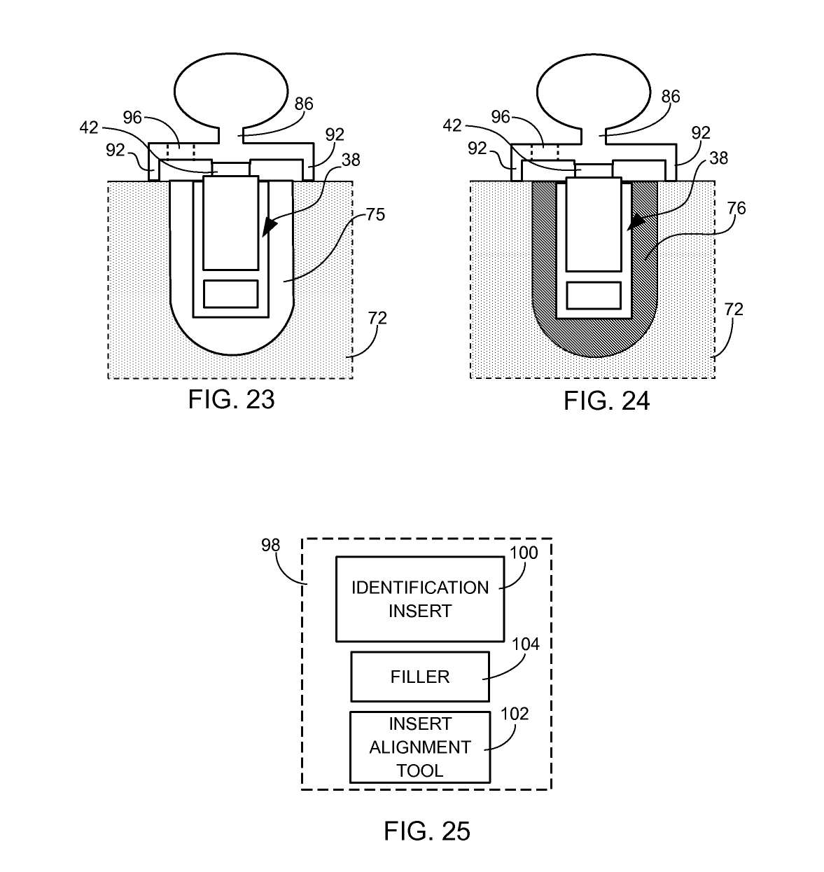

FIG. 22 illustrates a further embodiment of an insert alignment tool 86 that can be used in the installation method illustrated in FIGS. 14-18. Insert alignment tool 86 in this embodiment can include a tip 88, flange 90, and handle 94 much like the embodiment shown in FIGS. 19-21. Insert alignment tool 86 can further include spacers 92, which can be used to control an insertion depth of ID insert 38 into cavity 75. For example, as shown in FIG. 23, insert alignment tool can be plugged into plug receptacle 42 of ID insert 38 and used to insert ID insert 38 into cavity 75 until spacers 92 engage the surface of housing 92, which can control insertion depth. As above, the remaining cavity 75 around ID insert 38 can be filled with filler 76 as illustrated in FIG. 24. In some embodiments, an optional hole 96 can be defined in insert alignment tool 86 to provide access for the filler 76 to be filled into the remaining cavity 74 around the ID insert. When the filler 76 has cured, insert alignment tool 86 can be removed, as shown in FIG. 18, and the asset including housing 72 is ready for use with a security asset management system as described above.

FIG. 25 schematically illustrates an embodiment of a kit 98 for retrofitting an asset to make it monitorable by a security asset management system. Kit 98 can include an ID insert 100 having identification circuitry as discussed in the embodiments and their equivalents above, such as ID circuitry 40 of ID insert 42 shown in FIG. 3. Kit 98 can also include an insert alignment tool 102 for temporarily coupling to the ID insert 100 during the asset retrofit process as discussed in the embodiments and their equivalents above, such as any of those shown in FIGS. 19-24. Kit 98 can further include a filler 104 as discussed in the embodiments and their equivalents above. Other kit embodiments can include additional items (not shown), such as, but not limited to a) one or more additional insert alignment tools, for example each having spacers for a variety of insertion depths; b) separate spacers to enable a single insert alignment tool to be placed at a variety of corresponding depths; c) a drill bit for forming a cavity in an asset; and d) instructions for retrofitting an asset.

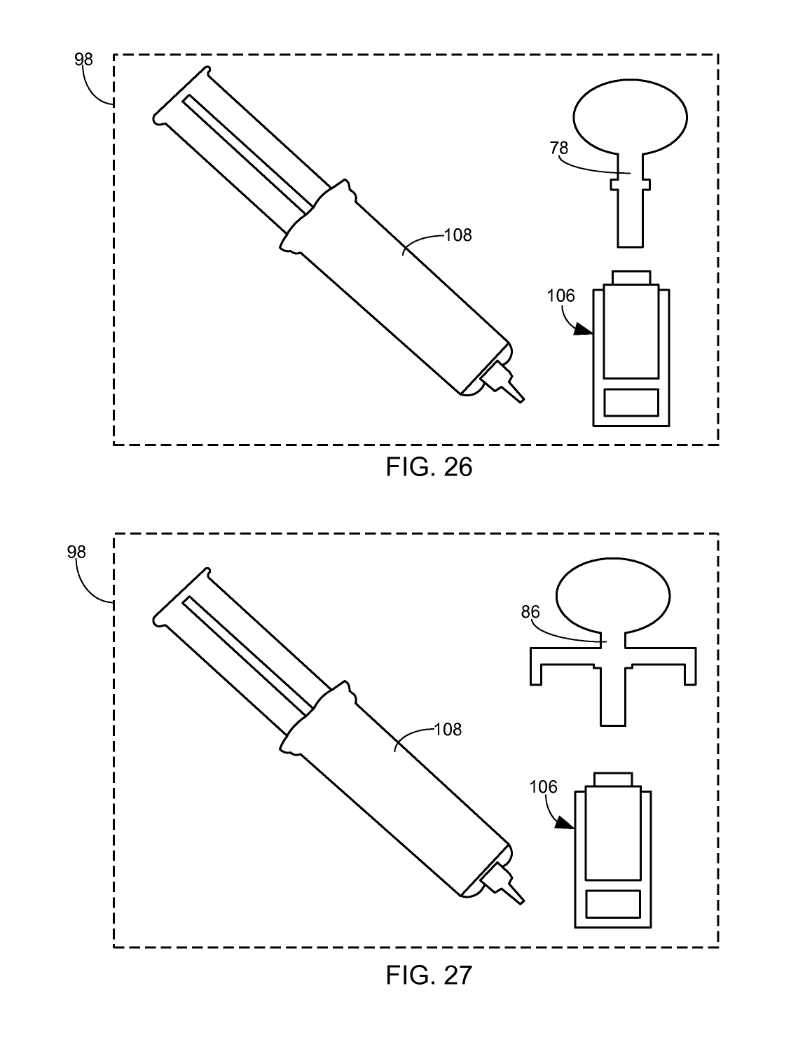

FIG. 26 schematically illustrates another embodiment of a kit 98 for retrofitting an asset to make it monitorable by a security asset management system. Here, kit 98 can include an ID insert 106 having a touch memory chip compatible for use with the Dallas Semiconductor 1-wire bus as discussed above. Kit 98 can also include an insert alignment tool 78, the details of which have been discussed above, and a filler 108, such as an epoxy.

FIG. 27 schematically illustrates a further embodiment of a kit 98 for retrofitting an asset to make it monitorable by a security asset management system. In this embodiment, kit 98 can include an ID insert 106 having a touch memory chip compatible for use with the Dallas Semiconductor 1-wire bus as discussed above. Kit 98 can also include an insert alignment tool 86, the details of which have been discussed above, as well as a filler 108, such as an epoxy.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having thus described several embodiments of the claimed invention, it will be rather apparent to those skilled in the art that the foregoing detailed disclosure is intended to be presented by way of example only, and is not limiting. Many advantages for the method, system, and kit for making an asset monitorable by a security asset management system have been discussed. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as can be specified in the claims. Accordingly, the claimed invention is limited only by the following claims and equivalents thereto. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An identification (ID) insert, comprising:
an ID communication interface;
identification circuitry electrically coupled to the ID communication interface and including an electronic identifier of the ID insert; and
a support layer coupled to and configured to support the ID communication interface and the identification circuitry.

2. The ID insert of claim 1, wherein the support layer is mounted in a cavity of a housing of an asset to be tracked with the ID communication interface exposed.

3. The ID insert of claim 1, wherein the ID communication interface includes at least one conductor compatible with the Dallas/Maxim One Wire Bus.

4. The ID insert of claim 1, wherein the ID communication interface includes a plug receptacle.

5. The ID insert of claim 1, wherein the support layer is mounted in a housing with the ID communication interface exposed and the housing includes a conduit by which the housing can be attached to an asset to be tracked, the ID insert thus housed comprising an ID enabler.

6. The ID insert of claim 5, wherein the housing is substantially cylindrical and the conduit is substantially perpendicular to a longitudinal axis of the housing.

7. The ID insert of claim 1, wherein the housing is substantially annular, the ID interface is accessible at a periphery of the housing, and the conduit is a substantially central hole of the housing formed along a longitudinal axis of the housing.

8. The ID insert of claim 7, wherein the substantially central hole of the housing is shaped to receive and engage an end of a lock, the lock including a tip shaped to correspond to a lock slot of an asset, wherein when the tip of the lock is inserted through the opening and into the lock slot, the end of the lock engages the housing, and when the lock is locked into the lock slot, the lock thereby retains the housing on the asset.

9. The ID enabler of claim 8, wherein the lock slot is a Kensington Security Slot and the lock includes a Kensington Security Slot compatible lock.

10. The ID enabler of claim 8, wherein the housing includes a cable ring.

11. A security asset management system, comprising:
an identification (ID) insert, including:
an ID communication interface;
identification circuitry electrically coupled to the ID communication interface and including a unique electronic identifier; and
a support layer supportingly coupled to the ID communication interface and the identification circuitry;
a cable including a connector compatible with the ID communication interface; and
a controller coupled to the cable, the cable placing the controller in electrical communication with the identification circuitry via the ID communication interface when the cable connector is connected to the ID communication interface of the ID insert, and the controller thereby selectively determining the presence and removal of an asset coupled to the ID insert based on the communications with the identification circuitry, the controller further selectively storing information about the asset based on the communications with the identification circuitry.

12. The security asset management system of claim 11, further comprising a communications device through which the controller is selectively coupled to a remote computing device to selectively allow a user of the remote computing device to access the controller.

13. The security asset management system of claim 11, further comprising a communications device through which the controller is selectively coupled to a remote computing device to selectively allow a server application of the remote computing device to access the controller.

14. A security asset management system comprising:
a server application running on a computing device that includes at least one server communications device;
at least one electronic identification (ID) device each including a unique electronic identifier associated with a respective asset to be tracked, each electronic ID device including an ID communication interface; and
at least one security asset manager (SAM) within which at least one asset to be tracked can be stored, each SAM including a controller, at least one respective first SAM communications device coupled to and responsive to the respective controller and with which the respective SAM selectively communicates with the server application via the at least one server communications device, and at least one second SAM communications device corresponding to an ID communication interface of the at least one electronic ID device that selectively enables communication between the controller and the at least one electronic ID device when the at least one electronic ID device is in the respective SAM.

15. The security asset management system of claim 14, wherein the electronic ID device is an ID insert including the ID communication interface, identification circuitry electrically coupled to the ID communication interface and including the electronic identifier of the ID insert, and a support layer coupled to and configured to support the ID communication interface and the identification circuitry.

16. The security asset management system of claim 15, wherein the electronic ID insert includes a housing in which the support layer is mounted with the ID communication interface accessible from an exterior of the housing, wherein the housing is part of an asset to be tracked and the electronic ID insert is mounted in a cavity of the housing.

17. The security asset management system of claim 15, wherein the electronic ID insert includes a housing in which the support layer is mounted with at least the ID communication interface accessible from an exterior of the housing at one end of the housing, the housing having a conduit at an opposite end such that the housing can be attached to an asset to be tracked via the conduit.

18. The security asset management system of claim 15, wherein the ID communication interface includes a plug receptacle mounted on the support layer.

19. The security asset management system of claim 14, wherein each SAM further includes a user interface (UI) enabling a local user to enter authentication information that the respective controller uses to determine whether the local user can access at least one asset to be tracked stored in the respective SAM, and the respective controller stores information related to each local user authentication information entry and any asset to be tracked a local user places in or removes from the respective SAM.

20. The security asset management system of claim 19, wherein the server application selectively receives via the at least one server communications device stored information from each SAM via the respective at least one respective first SAM communications device.

21. The security asset management system of claim 14, wherein each SAM further includes a user interface (UI) enabling a local user to enter authentication information that the controller sends to the server application, the server application uses the authentication information to determine whether the local user can access at least one asset to be tracked stored in the respective SAM, and the server application instructs the respective SAM controller allow access to at least one asset to be tracked that is stored in the respective SAM.
